(19) United States
(12) Patent Application Publication
(10) Pub. No.: US 2016/0209204 A1
(43) Pub. Date: Jul. 21, 2016

(54) METHOD AND APPARATUS FOR QUALITY TESTING TUBE BUNDLE

(71) Applicant: Caterpillar Inc., Peoria, IL (US)

(72) Inventors: Umesh S. Patil, Dunlap, IL (US); Douglas A. Rebinsky, Peoria, IL (US); Jon T. Immel, Chillicothe, IL (US); Michael S. Schertz, Edelstein, IL (US)

(73) Assignee: Caterpillar Inc., Peoria, IL (US)

(21) Appl. No.: 14/598,865

(22) Filed: Jan. 16, 2015

(51) Int. Cl. G01B 11/16

(52) U.S. Cl. CPC G01B 11/16

(57) ABSTRACT

A method for quality testing a tube bundle is provided. The tube bundle includes a plurality of tubes. The method includes providing a collimated light source and a receiving screen at a first end and a second end of the tube bundle respectively. The second end of the tube bundle is distal from the first end of the tube bundle. The method further includes directing a light beam through the tube bundle, wherein the light beam enters the tube bundle at an incident light intensity. The method includes passing the light beam through each of the plurality of tubes. The method also includes measuring, on the receiving screen, a received light intensity of the light beam exiting each of the plurality of tubes. The method further includes comparing the received light intensity with the incident light intensity, and determining a quality of the tube bundle based on the comparison.

### TECHNICAL FIELD

The present disclosure relates to a method and apparatus for quality testing a tube bundle, and more particularly to a method and apparatus for determining a quality of each of a plurality of tubes of the tube bundle.

### BACKGROUND

An oil cooler associated with an engine system generally includes a plurality of tubes that allow a passage of coolant therethrough in order to exchange heat and thereby cool the oil flowing over the tubes. The tubes are arranged to form a tube bundle, and this bundle is provided within a core or housing of the oil cooler. Sometimes, during assembly time, when the tube bundle is being positioned within the core of the oil cooler, the tubes in the tube bundle are susceptible to failure, collapse, or buckle thereof.

Oil coolers having a bent or deformed tube bundle may result in flow constraints for the coolant flowing therethrough, thereby decreasing an efficiency of the oil cooler. Further, excessive contact pressure between the tubes of the tube bundle may contribute to failures due to fretting. In some situations, the tubes may be damaged to an extent that may cause the coolant to leak from the tubes and mix with the oil flowing over the tubes. Such failures of the tubes may result in high system downtime, affect overall system productivity, and pose cost consideration issues.

Known methods to test a straightness of the tubes involve manually pushing a steel rod, having a slightly smaller diameter than the tubes, down through at least some of the tubes. The straightness of the tubes may be determined by checking if the steel rod will slide down the tubes without undo resistance. This method may be useful in detecting severe cases of bundle collapse or buckling of the tubes. However, this method is laborious and time-consuming. In addition, this method of testing may not detect cases of slight bundle buckling of the tubes and may be subject to operator attentiveness while performing the testing.

U.S. Pat. No. 4,690,556 describes a method for checking straightness of an elongated generally cylindrical bore, such as a capillary bore, includes directing a collimated light beam through the bore, with the bore skewed slightly with respect to the beam.

### SUMMARY OF THE DISCLOSURE

In one aspect of the present disclosure, a method for quality testing a tube bundle is provided. The tube bundle includes a plurality of tubes. The method includes providing a collimated light source at a first end of the tube bundle. The method also includes providing a receiving screen at a second end of the tube bundle. The second end of the tube bundle is distal from the first end of the tube bundle. The method further includes directing a light beam through the tube bundle, wherein the light beam enters the tube bundle at an incident light intensity. The method includes passing the light beam through each of the plurality of tubes. The method also includes measuring, on the receiving screen, a received light intensity of the light beam exiting each of the plurality of tubes. The method further includes comparing the received light intensity associated with each of the plurality of tubes with the incident light intensity. The method includes determining a quality of the tube bundle based on the comparison.

In another aspect of the present disclosure, a system for quality testing of a tube bundle is provided. The system includes a housing element defining an interior space therewithin; the housing element is configured to receive a plurality of tubes of the tube bundle. The system also includes a collimated light source positioned at a first end of the housing element. The collimated light source is configured to direct a light beam on the tube bundle such that the light beam enters the tube bundle at an incident light intensity. The system further includes a receiving screen positioned at a second end of the tube bundle, the second end being distal from the first end. The system also includes a testing module configured to be communicably coupled to the collimated light source and the receiving screen. The testing module is configured to measure a received light intensity of the light beam exiting each of the plurality of tubes. The testing module is also configured to compare the received light intensity associated with each of the plurality of tubes with the incident light intensity. The testing module is further configured to determine a quality of the tube bundle based on the comparison.

In yet another aspect of the present disclosure, a system for quality testing of an oil cooler is provided. The system includes a tube bundle of the oil cooler. The tube bundle includes a plurality of tubes. The system also includes a housing element defining an interior space therewithin. The housing element is provided in a surrounding contacting relationship with the plurality of tubes of the tube bundle. The system further includes a collimated light source positioned at a first end of the housing element. The collimated light source is configured to direct a light beam on the tube bundle such that the light beam enters the tube bundle at an incident light intensity. The system includes a receiving screen positioned at a second end of the tube bundle, the second end being distal from the first end. The system also includes a testing module communicably coupled to the collimated light source and the receiving screen. The testing module is configured to measure a received light intensity of the light beam exiting each of the plurality of tubes. The testing module is also configured to compare the received light intensity associated with each of the plurality of tubes with the incident light intensity. The testing module is further configured to determine a quality of the tube bundle based on the comparison.

Other features and aspects of this disclosure will be apparent from the following description and the accompanying drawings.

### BRIEF DESCRIPTION OF THE DRAWINGS

FIG. 1 is a perspective view of an exemplary tube bundle for an oil cooler, according to one embodiment of the present disclosure;

FIG. 2 is a schematic diagram of an apparatus for quality testing the tube bundle of FIG. 1, according to one embodiment of the present disclosure;

FIG. 3 is a perspective view of the apparatus of FIG. 2, according to one embodiment of the present disclosure;

FIG. 4 is an exemplary representation of received light intensity as projected on a receiving screen, for a single non-deviated tube, according to one embodiment of the present disclosure;

FIG. 5 is a exemplary representation of the received light intensity as projected on the receiving screen, for a single deviated tube, according to one embodiment of the present disclosure;

FIG. 6 is a exemplary representation of received light intensity as projected on the receiving screen, for a tube bundle having non-deviated tubes, according to one embodiment of the present disclosure;

FIG. 7 is a exemplary representation of received light intensity as projected on the receiving screen, for a tube bundle having deviated tubes, according to one embodiment of the present disclosure; and

FIG. 8 is a flowchart for a method of quality testing the tube bundle.

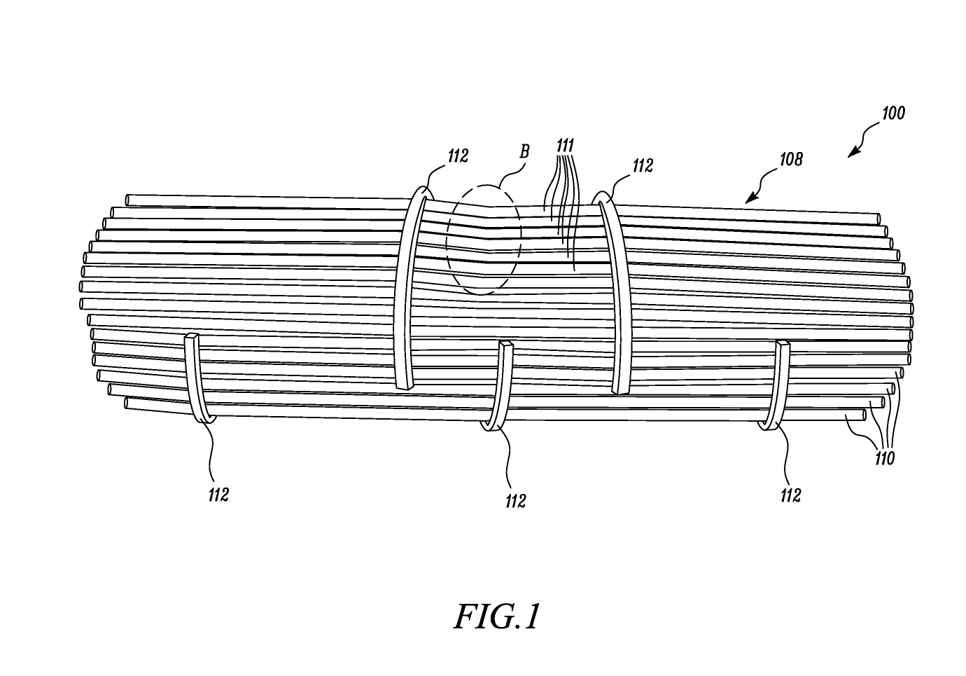

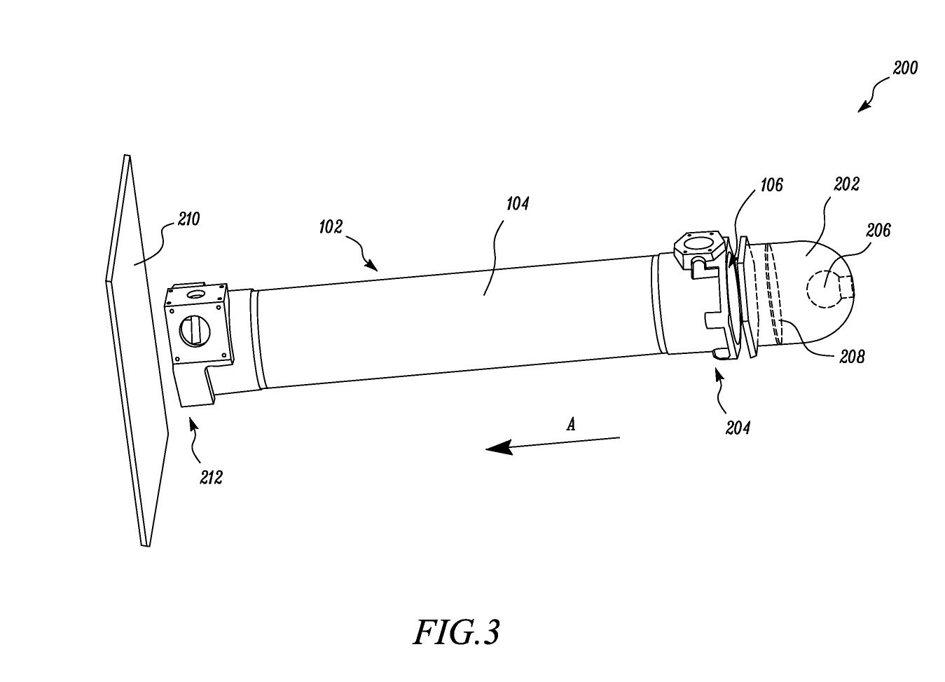

### DETAILED DESCRIPTION

Wherever possible, the same reference numbers will be used throughout the drawings to refer to the same or the like parts. Referring to FIGS. 1 and 3, an exemplary tube bundle 100 for an oil cooler 102 associated with an engine system is shown. Oil generally flows through the engine system for lubrication of engine components, and also to reduce surplus heat from surfaces of the engine components. As the engine components heat up during an operation thereof, a temperature of the oil also increases. The oil may require cooling in order to maintain the temperature of the oil below a threshold limit

The oil cooler 102 disclosed herein is configured to cool the oil flowing through various components of the engine system. In one embodiment, the oil cooler 102 may embody a radiator. A coolant may be used for cooling the oil flowing through the oil cooler 102. The coolant used for a particular application may vary based on a type of the oil cooler 102. In the illustrated embodiment, wherein the oil cooler 102 is embodied as a liquid-to-liquid cooler, the coolant may be any engine coolant known in the art. In one example, water may be used as the coolant. Alternatively, the coolant may be a mixture of water and an antifreeze solution, wherein the antifreeze solution may include ethylene glycol or propylene glycol.

It should be noted that the coolant flowing through the engine system may serve as a primary cooling source of the engine components. This coolant may be further directed towards the oil cooler 102 for cooling of the oil flowing therethrough. In an alternate embodiment, the oil cooler 102 may be embodied as an air-to-liquid cooler, wherein air may be used as a coolant for cooling purposes. The air may flow through the oil cooler 102 either at an ambient pressure or may be compressed to increase a pressure thereof. Alternatively, the oil cooler 102 may embody any heat exchanger known in the art. The oil cooler 102 may be associated with the engine system used for marine and/or automobile applications.

As shown in FIG. 3, the oil cooler 102 includes a housing element 104. The housing element 104 is embodied as a hollow tube defining an interior space 106 therewithin. The housing element 104 of the illustrated embodiment has a circular cross-section. Alternatively, the cross-section of the housing element 104 may be square, rectangular, elliptical, and the like. Further, the housing element 104 may have an inlet (not shown) and an outlet (not shown) for an ingress and egress of the oil for cooling thereof. The housing element 104 may be made of a known metal or polymer, based on an application thereof.

Referring to FIGS. 1 and 3, a tube bundle 100 is positioned within the oil cooler 102. As shown in FIG. 1, the tube bundle 100 includes a plurality of tubes 110. Each tube 110 of the tube bundle 100 may embody any of a circular tube, pipe, or conduit defining a flow passage therewithin. The flow passage of the tubes 110 is configured to allow the coolant to flow therethrough. Further, the oil cooler 102 may include a plurality of baffles 112. The baffles 112 may be provided at different locations along a length of the tube bundle 100. The baffles 112 may include a plurality of through-holes provided across a cross-section of the baffles 112. The tubes 110 of the tube bundle 100 may be configured to pass through the through-holes of the baffles 112. The baffles 112 may be made of plastic. In one embodiment, an adhesive may be used to couple the tubes 110 with the baffles 112. The tubes 110 of the oil cooler 102 may be made of any metal or polymer known in the art. In one example, the tubes 110 may be made of copper.

It should be noted that a cross section of the tube bundle 100 corresponds to a cross section of the housing element 104 (see FIG. 3), so that the tube bundle 100 may be received within the interior space 106 of the housing element 104. In the illustrated embodiment, the tube bundle 100 has a circular cross section. However, based on the cross section of the housing element 104, the cross section of the tube bundle 100 may vary and include any of a square, rectangular, or elliptical shape.

It should be noted that dimensions, such as, a diameter of the housing element 104, the tube bundle 100, and the tubes 110 may vary based on an application size. The number of tubes 110 per tube bundle 100 may also vary, and is based on the size of the housing element 104 and the operational requirements of the engine system.

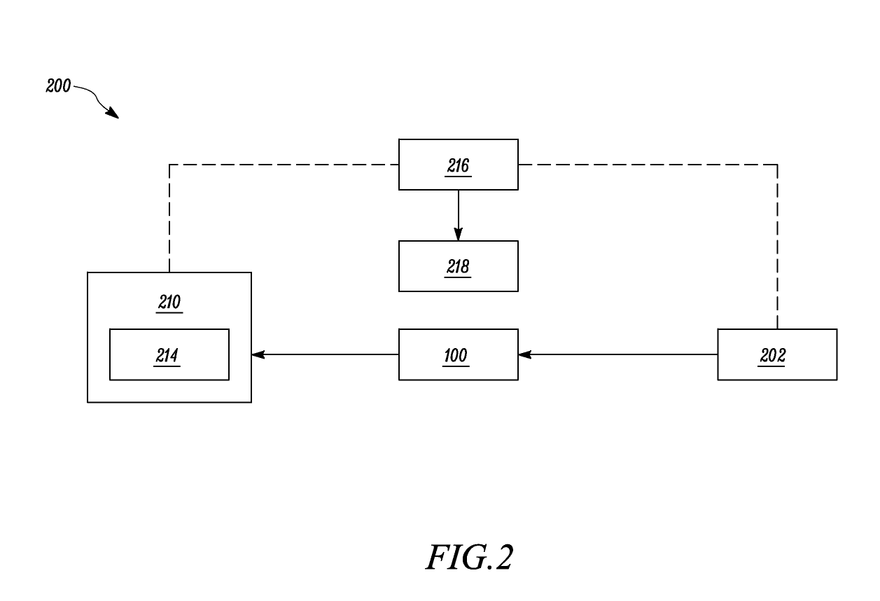

During an assembly of the tube bundle 100 and the housing element 104, the tubes 110 may bend or deviate from a linear orientation thereof. The tube bundle 100 has a bent area “B” formed due to bending of some of the tubes 110, hereinafter referred to as linearly deviated tubes 111. The present disclosure is related to a system 200 for quality testing of the tube bundle 100 of the oil cooler 102 and will be explained in detail with reference to FIGS. 2 and 3.

The system 200 includes a collimated light source 202. The collimated light source 202 is positioned at a first end 204 of the tube bundle 100. The collimated light source 202 is configured to direct a light beam on the tube bundle 100 such that the light beam enters the tube bundle 100 at an incident light intensity “i1”. The collimated light source 202 includes a lighting element 206. The lighting element 206 is configured to emit the light beam of visible light. In the illustrated embodiment, the lighting element 206 is configured to emit the light beam on the tube bundle 100, such that the light beam enters the tube bundle 100 at the incident light intensity “i1”. The lighting element 206 may include any one known light source, such as, conventional incandescent light bulbs, halogen bulb, LED lamps, fluorescent lamps, and the like.

The collimated light source 202 also includes a light filter element 208. The light filter element 208 may be a collimated light filtering element that is configured to align and focus the light beam onto the tube bundle 100. The collimated light source 202 may include any light filtering element known in the art, such as an optical filter. The light filter element 208 is positioned in front of the lighting element 206 in a direction “A” of travel of the light beam. The light beam emitted by the lighting element 206 passes through the light filter element 208, after which the light beam passes through each of the plurality of tubes 110 of the tube bundle 100. It should be noted that the light beam enters the plurality of tubes 110 with the incident light intensity “i1”.

The system 200 includes a receiving screen 210. The receiving screen 210 is positioned at a second end 212 of the housing element 104, wherein the second end 212 is longitudinally spaced apart and distal from the first end 204. Further, the light beam exits each of the plurality of tubes 110 at an intensity “i2” which may be equal to or different than the incident light intensity “i1”. The receiving screen 210 may be configured to receive the light beam having the intensity “i2”. The intensity “i2” will be referred to as received light intensity “i2” hereafter. It is assumed that the incident light intensity “i1” at the first end 204 is similar to the received light intensity “i2” at the second end 212 for non-deviated tubes. But slight deviation in intensities at the first end 204 and the second end 212 might exist for a non-deviated tube, however for the present disclosure the deviation is considered negligible. Henceforth, for any non-deviated tube, the incident light intensity “i1” will be considered similar to the received light intensity “i2”.

The receiving screen 210 may have a substantially planar surface. The receiving screen 210 may embody any known screen capable of receiving light thereon. In one example, the receiving screen 210 may be a digital screen. It should be noted that a perimeter of the receiving screen 210 may be greater than a circumference of the cross-section of the housing element 104.

The receiving screen 210 includes a light intensity sensor 214 (see FIG. 2). The light intensity sensor 214 is configured to measure the received light intensity “i2” of the light beam exiting each of the plurality of tubes 110. The light intensity sensor 214 is coupled with the receiving screen 210. The light intensity sensor 214 may include any type of known light sensing device, for example, photo-emissive cells, photo-conductive cells, photo-voltaic cells, and photo-junction cells.

The system 200 includes a testing module 216. The testing module 216 is communicably coupled to the light intensity sensor 214. The testing module 216 is configured to receive a signal indicative of the received light intensity “i2” measured by the light intensity sensor 214. Further, the testing module 216 is also communicably coupled to the collimated light source 202. The testing module 216 is configured to receive a signal indicative of the incident light intensity “i1” emitted by the lighting element 206.

The testing module 216 is configured to compare the received light intensity “i2” with the incident light intensity “i1”. The testing module 216 is configured to determine a quality of the tube bundle 100 based on the comparison. More particularly, based on the signals indicative of the received light intensity “i2” and the incident light intensity “i1”, the testing module 216 is configured to identify deviation of at least one of the plurality of tubes 110 from a linear orientation thereof.

As discussed earlier, the light beam having the incident light intensity “i1” passes simultaneously through each of the tubes 110 of the tube bundle 100. Based on a presence of any deviations or bends along a length of the tubes 110, the received light intensity “i2” may be same or different from the incident light intensity “i1”. For example, the received light intensity “i2” may be equal to the incident light intensity “i1” when the tubes 110 do not have any deviations along the length of the tubes 110.

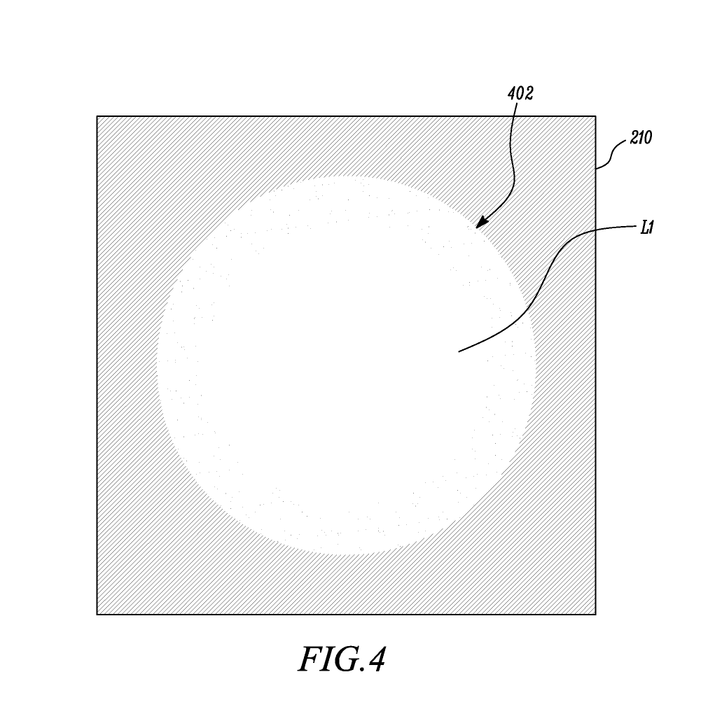

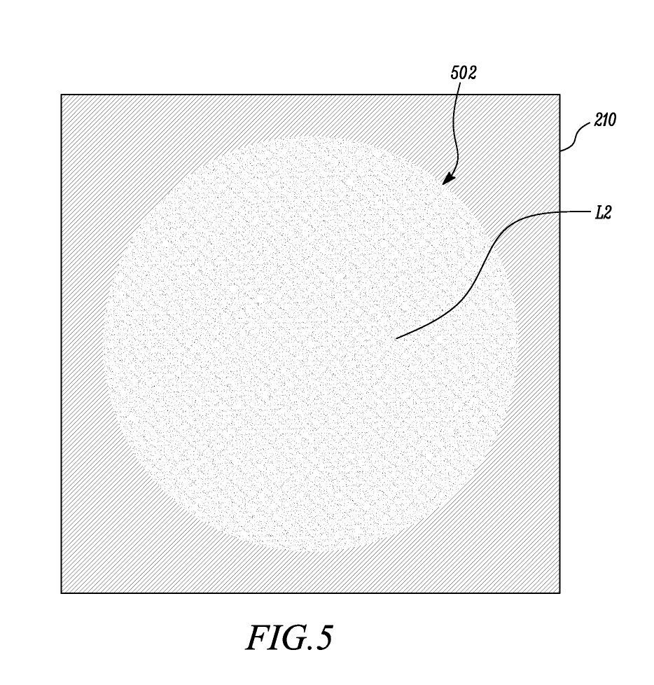

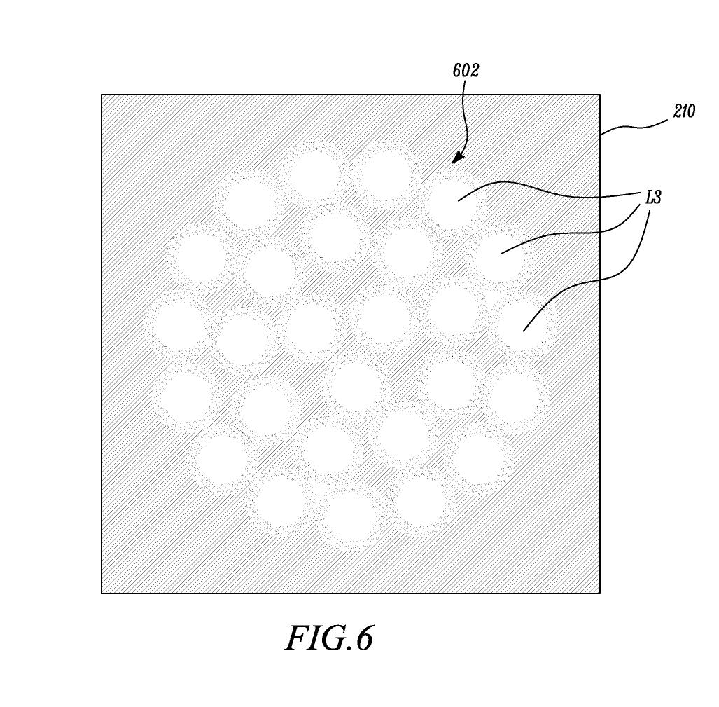

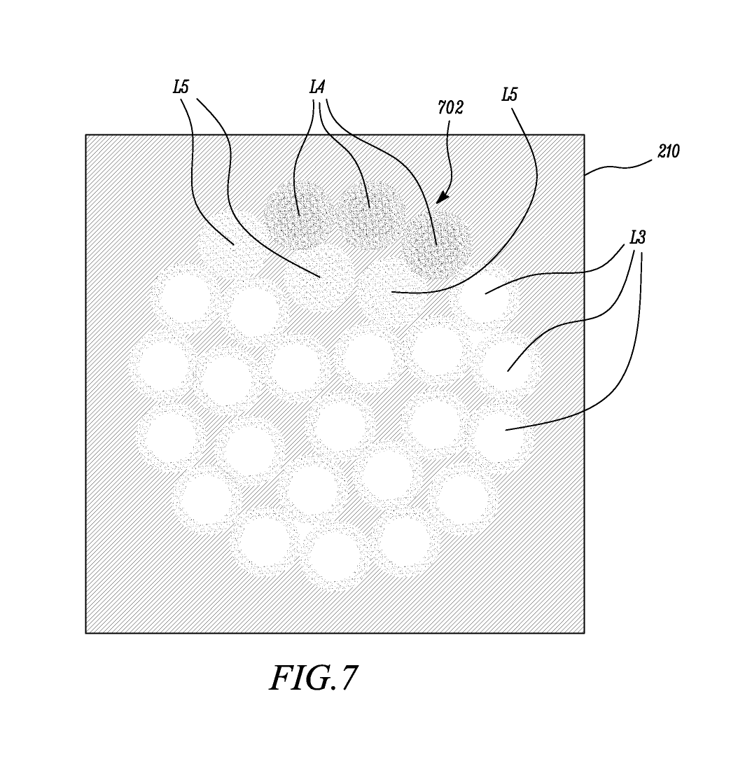

An exemplary representation of the received light intensities “L1” and “L2” for a single tube 110 of the tube bundle 100 is shown in FIGS. 4 and 5 respectively, such that the light beam has the incident light intensity “I1” on the single tube 110. Whereas, the received light intensities “L3”, “L4”, and “L5” for the tube bundle 100 is shown in FIGS. 6 and 7 respectively, such that the light beam has the incident light intensity “I2” on the tube bundle 100.

FIG. 4 depicts the received light intensity “L1” indicative of a single tube having no linear deviations, hereinafter referred to as a single non-deviated tube. In this case, a light pattern 402 having the received light intensity “L1” may be observed on the receiving screen 210 when the received light intensity “L1” is approximately equal to the incident light intensity “I1”. It should be noted that the receiving screen 210 may be of any dark or light color, for example, white, grey, or black color so that the received light intensity “L1” may be clearly visible thereon.

Referring to FIG. 5, an exemplary representation of the received light intensity “L2” of a single tube having deviations from the linear orientation thereof, hereinafter referred to as a single deviated tube is illustrated. In this case, a light pattern 502 having the received light intensity “L2” may be observed on the receiving screen 210 when the received light intensity “L2” is not equal to or is lesser than the incident light intensity “I1”. It should be noted that the collimated light source 202 of the present disclosure is configured to emit and direct the light beam through each of the tubes 110 of the tube bundle 100 simultaneously. The representations for the non-deviated and deviated single tubes shown in FIGS. 4 and 5 respectively are merely for exemplary purposes.

FIGS. 6 and 7 illustrate exemplary light patterns 602, 702 respectively captured on the receiving screen 210 when the light beam having the incident light intensity “I2” is incident on the tube bundle 100. Referring to FIG. 7, in this case, the received light intensity “L3” of all the tubes 110 of the tube bundle is approximately equal to the incident light intensity “I2”. As shown, the received light intensity “L3” for each of the tubes 110 is uniform. Accordingly, due to the approximate matching of the incident and received light intensities “I2” and “L3” respectively, the testing module 216 may determine that none of the tubes 110 of the tube bundle 100 are deviated from the linear orientation thereof.

Referring now to FIG. 7, in another case, the light pattern 702 captured on the receiving screen 210 may indicate that the tubes 110 near a top portion of the tube bundle 100 have a comparatively lower received light intensity “L4”, “L5” than the incident light intensity “I2” on the tube bundle 100. Further, in one embodiment, the received light intensity “L4”, “L5” of these tubes may also be lesser as compared to the received light intensity “L3” of the remaining tubes 110. The tubes 110 having the received light intensity “L4”, “L5” indicate that these tubes 110 have deviations along the length of the tube bundle 100. In the illustrated embodiment, six linearly deviated tubes 111 of the tube bundle 100 have deviations across their length.

It should be noted that the light patterns 402, 502, 602, 702 illustrated in the accompanying figures are exemplary in nature and do not limit the scope of the present disclosure. The light patterns 402, 502, 602, 702 formed on the receiving screen 210 may vary based on the tube bundle design and the light beam parameters of the collimated light source 202.

Based on detection of the deviation from the linear orientation in any of the tubes 110 in the tube bundle 100, the testing module 216 is configured to trigger an alert notification to notify the operator of the defect in the tube bundle 100. The alert notification may be provided via an output module 218 (see FIG. 2). The output module 218 is communicably coupled to the testing module 216 in a wired or wireless manner. The output module 218 is configured to receive information of the quality of the tube bundle 100. The output module 218 is also configured to provide an indication to the operator, of the identified received light intensity “i2” for each of the tubes 110 of the tube bundle 100. The output module 218 may also be configured to indicate the number of tubes 110 that have deviations from the linear orientation.

The output module 218 may be mounted at a location such that the output module 218 may be viewable to the operator. The output module 218 may embody a visual output or an audio output. In one example, wherein the output module 218 is embodied as a visual output, the output module 218 may include any one of a digital display device, an LCD device, an LED device, a CRT monitor, a touchscreen device, or any other display device known in the art. In one example, the output module 218 may notify an operator shop supervisor regarding the quality of the tube bundle 100 through a cellular text message, such as an Andon system.

Alternatively, the output module 218 may include an indicator light. An LED light or an LCD light may be used to alert the operator of the quality of the tube bundle 100. For example, if the received light intensity “i2” for all of the tubes 110 is approximately equal to the incident light intensity “i1”, the indicator light may glow of a green color, indicating to the operator that the quality of the tube bundle 100 meets set quality expectations. In another example, if the received light intensity “i2” for one or more of the tubes 110 is lesser than the incident light intensity “i1”, the indicator light may glow of a red color, thereby indicating to the operator that the quality of the tube bundle 100 does not meet set quality expectations. In a situation wherein the output module 218 is embodied as the audio output, an audio clip may be heard, thereby alerting the operator of the quality of the tube bundle 100. It should be noted that the output module 218 may include any other means other than those listed above.

The testing module 216 may include an algorithm that is configured to perform the above described operational steps to determine the quality of the tubes 110 of tube bundle 100. Alternatively, the testing module 216 may embody a single microprocessor or multiple microprocessors for receiving signals from the receiving screen 210, the light intensity sensor 214, or the collimated light source 202 of the system 200. Numerous commercially available microprocessors may be configured to perform the functions of the testing module 216. It should be appreciated that the testing module 216 may embody a machine microprocessor capable of controlling numerous machine functions. It should be noted that the testing module 216 may additionally include other components and may also perform other functions not described herein.

### INDUSTRIAL APPLICABILITY

The present disclosure is directed towards the use of a non-destructive quality testing system 200 for determining the quality of the tube bundle 100. The system 200 includes the collimated light source 202 present at the first end 204 of the tube bundle 100. The collimated light source 202 is configured to direct the light beam through each of the tubes 110 of the tube bundle 100 at the incident light intensity “i1”. Further, the system 200 includes the receiving screen 210 positioned at the second end 212 of the oil cooler 102.

The receiving screen 210 is configured to receive the light beams that have passed through the tubes 110 at the received light intensity “i2”. Further, the receiving screen 210 includes the light intensity sensor 214. The light intensity sensor 214 is configured to measure the received light intensity “i2”. The system 200 includes the testing module 216. The testing module 216 is configured to compare the received light intensity “i2” and the incident light intensity “i1”. Based on the difference between the received light intensity “i2” and the incident light intensity “i1”, the output module 218 of the system 200 is configured to alert the operator of the quality of the tube bundle 100.

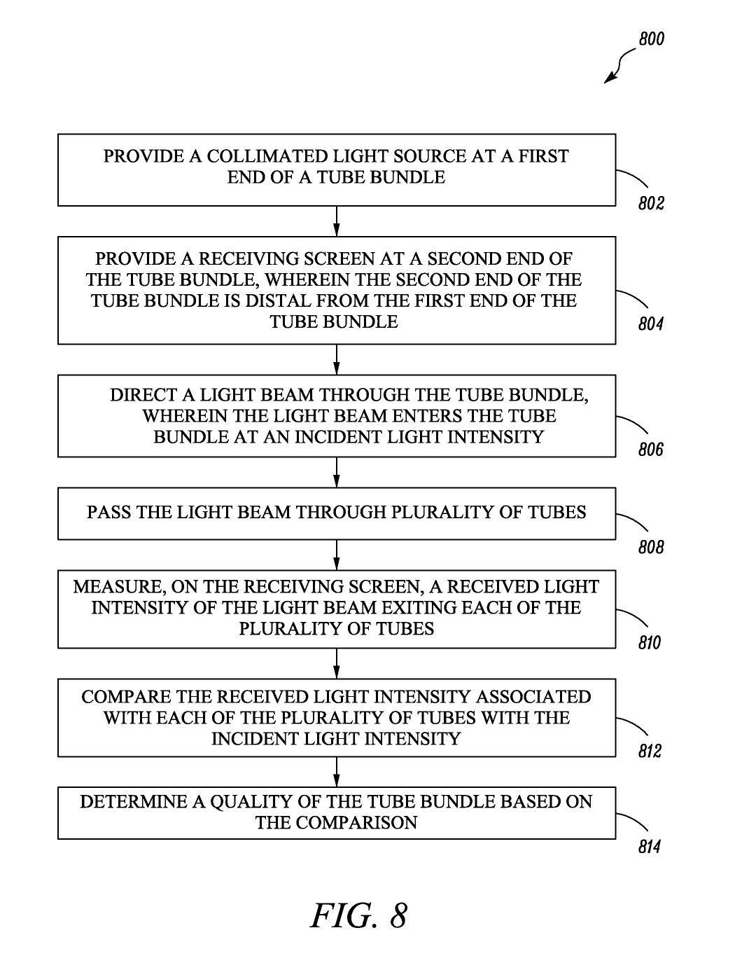

FIG. 8 is a flowchart for a method 800 of quality testing the tube bundle 100. The tube bundle 100 includes the plurality of tubes 110. The plurality of tubes 110 is bundled to form the tube bundle 100 prior to the testing. Further, the plurality of tubes 110 of the tube bundle 100 are received into the housing element 104 prior to the testing. At step 802, the collimated light source 202 is provided at the first end 204 of the tube bundle 100. At step 804, the receiving screen 210 is provided at the second end 212 of the tube bundle 100, wherein the second end 212 of the tube bundle 100 is distal from the first end 204 of the tube bundle 100. At step 806, the light beam is directed through the tube bundle 100, wherein the light beam enters the tube bundle 100 at the incident light intensity “i1”. At step 808, the light beam is passed through each of the plurality of tubes 110.

At step 810, the received light intensity “i2” of the light beam exiting each of the plurality of tubes 110 is captured from the receiving screen 210 by the testing module 216. At step 812, the received light intensity “i2” associated with each of the plurality of tubes 110 is compared with the incident light intensity “i1” on the tube bundle 100. At step 814, the quality of the tube bundle 100 is determined based on the comparison.

The testing module 216 is configured to identify the deviation of at least one of the plurality of tubes 110 from the linear orientation thereof, when the received light intensity “i2” of any of the tubes is different from or does not match with the incident light intensity “i1” on the tube bundle 100. For the linear deviated tubes 111, the received light intensity “i2” is lesser than the incident light intensity “i1” on the tube bundle 100. Further, the output module 218 is configured to trigger the alert notification based on the identification of the deviation of at least one of the plurality of tubes 110 from the linear orientation.

The method 800 of the present disclosure is configured to determine the quality of the tube bundle 100. Also the method 800 does not cause any damage to the tubes 110 during the testing of the tube bundle 100. The method 800 disclosed herein is cost effective and is less time consuming Further, it is easy to test the tubes 110 using the method 800 of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A method for quality testing a tube bundle, the tube bundle including a plurality of tubes for the passage of coolant, the method comprising:
providing a collimated light source at a first end of the tube bundle;
providing a receiving screen at a second end of the tube bundle, wherein the second end of the tube bundle is distal from the first end of the tube bundle;
directing a light beam through the tube bundle, wherein the light beam enters the tube bundle at an incident light intensity;
passing the light beam through each of the plurality of tubes;
measuring, on the receiving screen, a received light intensity of the light beam exiting each of the plurality of tubes;
comparing the received light intensity associated with each of the plurality of tubes with the incident light intensity; and
determining, based on the comparison, a quality of the tube bundle indicative of deviations of one or more tubes from a linear orientation, such deviations being indicative of coolant flow constraints.

2. The method of claim 1 wherein the determining step further comprises:
identifying a deviation of at least one of the plurality of tubes from a linear orientation thereof if the received light intensity associated with at least one of the plurality of tubes of the tube bundle is lesser than the incident light intensity.

3. The method of claim 2 further comprising:
triggering an alert notification based on the identification of the deviation of at least one of the plurality of tubes from the linear orientation thereof.

4. The method of claim 1 further comprising:
bundling of the plurality of tubes to form the tube bundle prior to the testing.

5. The method of claim 1 further comprising:
receiving the plurality of tubes of the tube bundle into a housing element prior to the testing.

6. A system for quality testing of a tube bundle, the system comprising:
a housing element defining an interior space therewithin, the housing element configured to receive a plurality of tubes of the tube bundle for the passage of coolant;
a collimated light source configured to be positioned at a first end of the housing element, wherein the collimated light source is configured to direct a light beam on the tube bundle such that the light beam enters the tube bundle at an incident light intensity;
a receiving screen configured to be positioned at a second end of the tube bundle, the second end being distal from the first end; and
a testing module configured to be communicably coupled to the collimated light source and the receiving screen, the testing module configured to:
measure a received light intensity of the light beam exiting each of the plurality of tubes;
compare the received light intensity associated with each of the plurality of tubes with the incident light intensity; and
determine, based on the comparison, a quality of the tube bundle indicative of deviations of one or more tubes from a linear orientation, such deviations being indicative of coolant flow constraints.

7. The system of claim 6, wherein the collimated light source includes a light filter element and a lighting element.

8. The system of claim 6 further comprising an output module configured to be coupled to the testing module, the output module configured to provide a notification of the determined quality of the tube bundle.

9. The system of claim 6, wherein the testing module is further configured to identify a deviation of at least one of the plurality of tubes from a linear orientation thereof if the received light intensity associated with at least one of the plurality of tubes is lesser than the incident light intensity.

10. The system of claim 9, wherein the testing module is further configured to trigger an alert notification based on the identification of the deviation of at least one of the plurality of tubes from the linear orientation thereof.

11. The system of claim 6 further comprising a light intensity sensor configured to be coupled to the receiving screen.

12. A system for quality testing of an oil cooler, the system comprising:
a tube bundle of the oil cooler, the tube bundle including a plurality of tubes for the passage of coolant;
a housing element defining an interior space therewithin, the housing element provided in a surrounding contacting relationship with the plurality of tubes of the tube bundle;
a collimated light source positioned at a first end of the housing element, wherein the collimated light source is configured to direct a light beam on the tube bundle such that the light beam enters the tube bundle at an incident light intensity;
a receiving screen positioned at a second end of the tube bundle, the second end being distal from the first end; and
a testing module communicably coupled to the collimated light source and the receiving screen, the testing module configured to:
measure a received light intensity of the light beam exiting each of the plurality of tubes;
compare the received light intensity associated with each of the plurality of tubes with the incident light intensity; and
determine, based on the comparison, a quality of the tube bundle indicative of deviations of one or more tubes from a linear orientation, such deviations being indicative of coolant flow constraints.

13. The system of claim 12, wherein the collimated light source includes a light filter element and a lighting element.

14. The system of claim 12 further comprising an output module configured to be coupled to the testing module, the output module configured to provide a notification of the determined quality of the tube bundle.

15. The system of claim 12, wherein the testing module is further configured to identify a deviation of at least one of the plurality of tubes from a linear orientation thereof if the received light intensity associated with at least one of the plurality of tubes of the tube bundle is lesser than the incident light intensity.

16. The system of claim 15, wherein the testing module is further configured to trigger an alert notification based on the identification of the deviation of at least one of the plurality of tubes from the linear orientation thereof.

17. The system of claim 12 further comprising a light intensity sensor coupled to the receiving screen.
